(19) United States
(12) Patent Application Publication
(10) Pub. No.: US 2011/0117282 A1
(43) Pub. Date: May 19, 2011

(54) PROCESS OF OBTAINING A POLYURETHANE COATING COMPOSITION HAVING EXTENDED POT-LIFE

(75) Inventors: Jean-Marie Bernard, Saint-Laurent D'Agny (FR); Corinne Duffy (Varon), Meyzieu (FR)

(73) Assignee: Rhodie Chimie, Aubervilliers Cedex (FR)

(21) Appl. No.: 12/892,258

(22) Filed: Sep. 28, 2010

Related U.S. Application Data
(63) Continuation-in-part of application No. 10/539,998, filed on Jun. 17, 2005, now abandoned.

(30) Foreign Application Priority Data
Sep. 28, 2002 (FR) 02/16633

(51) Int. Cl. B05D 3/00; C09D 175/12

(52) U.S. Cl. 427/391; 524/590; 427/385.5; 427/393.5

(57) ABSTRACT

The invention relates to polyurethane coating compositions having a pot-life of at least 8 hours and a de-blocking temperature of 50-100° C. The composition comprises: a) a blocked isocyanate formed by mixing at least one isocyanate functional compound with at least one imidazole and b) at least one polyol. The composition can be used on heat sensitive substrates. Methods of making such a composition are also described. The invention was applications in the coating industry.

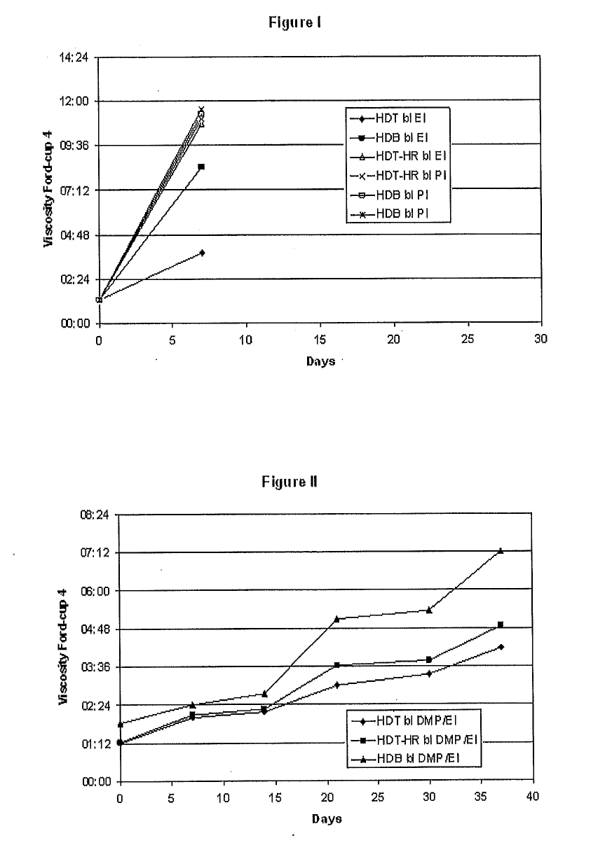

This application is a continuation-in-part of co-pending U.S. application Ser. No, 10/539,998, filed Jun. 17, 2005, which is an application under 35 U.S.C. §371 of International Application Number PCT/FRO03/003793, filed on Dec. 18, 2003, which claims priority to French application 02/16633, filed Dec. 24, 2002.

The present invention relates to a polyurethane coating composition that can be used on heat sensitive substrates, where the composition has a pot-life of at least 8 hours and a de-blocking temperature of 50-100° C. The polyurethane coating composition is formed by a process comprising the steps of a) mixing an isocyanate with an imidazole to form an addition product and b) mixing the addition product with a polyol. In a further aspect, the present invention refers to a method of obtaining a coated substrate using said coating composition.

The coatings industry, and in particular the paint and varnish industries, have available two types of compositions for producing high quality polyurethane paints or varnishes. According to a first type, use is made of true polyisocyanates, that is to say non-blocked polyisocyanates, and of polyols of a certain type. The coating thus obtained is of high quality. However, the disadvantage of this technique is the speed with which polycondensation, resulting ipso facto in crosslinking, takes place. Usually, once the mixture has been prepared, the paint has to be applied very quickly, generally within a time of less than a couple of hours. This technique results in relatively high wastage during for instance untimely shutdowns of the paint line.

This type of paint and composition is denoted under the expression “2K” (abbreviation of the German expression meaning two components). A second type of composition has been developed; these are compositions denoted by “1K” and being composed of blocked isocyanates having a relatively high de-blocking temperature, in the vicinity of 140° C. with catalyst. The polyols used for these compositions are different in nature.

One of the objects of the present invention is to provide isocyanate-polyol compositions giving paints or varnishes exhibiting properties at least equal to that of “2K” mixtures.

Another object of the present invention is to provide a polyurethane coating composition having a pot-life, as a mixture, at ambient temperature of at least equal to 8 h, preferably of at least 24 hours. Yet another aim of the present invention is to provide a polyurethane coating compositions that can be used on heat sensitive substrates such as wood, plastic and paper, thus having a de-blocking temperature of at most 100° C., preferably between 50° C. and 100° C., during for instance 30-120 minutes.

Two component (2K) polyurethanes are so called as the polyol (hydroxylated resin) and the isocyanate are supplied in two separate containers; they are mixed during application and, consequently, an increase in the viscosity of application occurs due to the reaction between the polyol and the isocyanate in the pot. The pot-life is the time during which the mixture can be employed and is measured as the time necessary for the doubling of the initial viscosity. Two component polyurethanes are multipurpose and they can be applied to all substrates, including heat sensitive substrates such as wood, plastic and paper. Drying is carried out in the ambient air or is alternatively accelerated by heating.

In the case of one component (1K) polyurethanes, the blocked isocyanate does not react at ambient temperature with the polyol. The two components are therefore formulated and stored in the same pot. In this instance, the polyurethane does not have a pot-life. The disadvantage of such a system is that the reaction between the isocyanate and the polyol can only take place after thermal de-blocking, generally above 140° C., which means that the substrate cannot be heat sensitive.

Blocked isocyanates which de-block at temperatures below 100° C. exhibit the advantage of being used on some plastics, such as polypropylene or polyamide, while not having the constraint of the pot-life. The major advantage of such isocyanates is that of being used in a two component system but not having the constraint of the pot life. In this case, the pot-life will be greater than for instance 24 hours, instead of a few hours. This type of product is particularly advantageous in the case of catalyzed two component systems, the pot life of which is necessarily shorter, such as 2 to 4 hours.

The advantage of an isocyanate having an extended pot-life lies in an extension of the operating life of the product on line, increase in the productivity, no problem of the product setting solid in static mixers and spray guns, no need to clean the application equipment during pauses, better efficiency with regard to the amount of paint employed, and the like.

Thus, the present invention is targeted at improving the productivity by sparing the user the trouble of preparing the coating composition all the time, as is required by compositions formulated with polyisocyanates comprising free functional groups, which compositions are denoted under the expression “2K”. Furthermore, a loss of material during breakdowns on the line is avoided.

Furthermore, the present invention makes it possible to prevent variations in paint/varnish baths and more specifically in preparations since, on the one hand, there will be fewer preparations for a given time period and, on the other hand; the variation according to the age of the preparation will be lower.

A problem related to long pot-life time is that blocked isocyanates frequently have a tendency to crystallize, which interferes with the subsequent crosslinking. It is, thus, a further an object of the present invention to prevent the blocked isocyanates to crystallize. The blocking technique of the present invention makes it possible to confer, on the coating thus obtained, properties at least comparable with those obtained with non-blocked polyisocyanates. The blocking technique, furthermore, makes possible physical stability during the storage of the coating formulation, that is to say that there is neither phase separation nor crystallization during the pot-life time.

### BRIEF DESCRIPTION OF THE DRAWINGS

Figures I and II show the stability of varnishes having different blocked isocyanates on storage at 23° C. without catalyst.

These and other objects, which will become apparent subsequently, are achieved by a process of obtaining a polyurethane coating composition that can be used on heat sensitive substrates, which composition has a pot-life of at least 8 hours and a de-blocking temperature of 50-100° C., said process comprises a) mixing at least one isocyanate functional compound with at least one imidazole selected from the group consisting of a 2-, 4- or 5-monoalkyl substituted imidazole, a 2,4- or 4,5-dialkyl substituted imidazole and a 2,4,5-trialkyl substituted imidazole, yielding at least one blocked isocyanate wherein at least 75% of reactive isocyanate groups are blocked, and b) mixing yielded at least one blocked isocyanate with at least one polyhydric compound. Said alkyl is in preferred embodiments C₁-C₁₀, such as C₄, C₅ or C₆, linear or branched alkyl or cycloalkyl.

Preferred imidazoles and derivatives include monosubstituted 2-methylimidazole, 4-methyl imidazole, 2-ethylimidazole, 2-propylimidazole, 2-isopropylimidazole, 2-ethyl-4-methylimidazole and 4-methyl-5-hydroxymethylimidazole. Further suitable imidazoles possible to use as blocking agent include 2-phenylimidazole, 4-methyl-2-phenylimidazole, 4-ethyl-5-methylimidazole carboxylate, and 2,4,5-triphenylimidazole. Monosubstituted imidazoles are most preferably substituted on the carbon situated between the two nitrogens. The blocked aliphatic isocyanate can be completely blocked by said imidazole, or comprise a certain amount of free isocyanate functional groups.

In addition, said blocked isocyanate may comprise other blocking agents than said imidazole, such as pyrazoles, preferably dimethylpyrazole, 2-hydroxypyridine and its derivatives, preferably 2-hydroxy-4-methylpyridine, 2-hydroxy-6-methylpyridine, 3-methoxy-2-pyridone, 2,6-dihydroxypyridine or 2-hydroxy-6-methylpyridine carboxylic acid, and triazole derivatives. In such a case, it is preferable that at least 50%, preferably at least 65% and more preferably at least 75%, of the isocyanate functional groups are blocked using said imidazole.

In various preferred embodiments said polyhydric compound is advantageously a compound having a hydroxyl content of between 1 and 5 g/100 g, most preferably between 3.5 and 4.5 g/100 g, expressed on the dry material. Preferred polyhydric compounds can be exemplified by hydroxylfunctional polyacrylates and polyesters or alkyds, including mixtures thereof, having a molecular weight (Mw) of between 3,000 and 50,000 g/mole, such as between 5,000 and 30,000 g/mole. Suitable polyhydric compounds are as described on pages 40 to 49 of “Waterborne & Solvent Based Surface Coating—Resins and Their Applications”, vol. III, John Wiley & Sons, 1998. The polyhydric compound is typically in solution in an organic solvent, such as an ester, an aromatic hydrocarbon, an ether, an ether ester or an amide. Use may also be made of aqueous dispersions, emulsions and solutions of polyhydric compounds. Said polyhydric compound may be used at a solid content of 60-100%.

Preferred isocyanate functional compounds include aliphatic isocyanate monomers, that is to say non-polycondensed, having two or more isocyanate groups, and larger molecules resulting from one or more oligocondensation(s), as well as mixtures of oligocondensate(s), and monomer(s). The most preferred oligocondensates are biurets, dimers trimers, such as compounds comprising isocyanuric rings obtained from three isocyanate functional groups. Said isocyanate functional compounds can suitably be exemplified by isocyanate monomers selected from the group consisting of tetramethylene diisocyanate, hexamethylene diisocyanate including its isomers, methylpentamethylene diisocyanate, isophorone diisocyanate, tetrahydrofuran diisocyanate, 1,3-bis(isocyanatomethyl)cyclohexane, norbornane diisocyanate, and cyclohexane-1,4-diisocyanate, and oligocondensed isocyanates having a molecular weight of for instance at least 1,000 g/mole preferably approx. 2,000 g/mole or 4,000 g/mole, such as biurets, dimers, trimers and isocyanurates comprising one or more units derived from any of said isocyanate monomers as well as mixtures of or comprising said monomers and/or said oligocondensates. Isocyanates advantageously used in the process of the present invention include those of the biuret type and those for which the dimerization or trimerization reaction has resulted in four, five or six membered rings, such as isocyanuric rings. Further included isocyanates are compounds resulting from condensations with diols and triols, yielding carbamates and allophanates, under substoichiometric conditions.

Preferred embodiments of said isocyanate compound are for example compounds having isocyanurate functional groups, obtained by, for instance, catalyzed cyclocondensation of isocyanate functional groups with themselves, compounds having urea functional groups, obtained by, for instance, reaction of isocyanate functional groups with water or primary or secondary amines, compounds having biuret functional groups, obtained by, for instance, condensation of isocyanate functional groups with themselves in the presence of water and a catalyst or by reaction of isocyanate functional groups with primary or secondary amines, compounds having urethane functional groups, obtained by, for instance, reaction of isocyanate functional groups with hydroxyl functional groups, compounds having allophanate functional groups, obtained by reaction of isocyanate functional groups with urethane functional groups, compounds having uretidinedione functional groups, obtained by cyclodimerization, optionally catalyzed, of isocyanate functional groups with themselves.

The coating composition obtained by the present invention can of course also include one or more aromatic isocyanate monomers or oligocondensates.

The coating composition obtained by the process of the present invention can additionally and advantageously comprises at least one pigment, surface active agent, organic solvent, water, catalyst and/or dehydrating agent.

The coating composition obtained by the present invention is favorably used in organic solvent borne systems, but is also suitable for waterborne systems, such as dispersions in an aqueous phase. Such a dispersion typically involves the use of surface active agents and in particular of dispersants. Suitable solvents include aromatic solvents, such as benzene, ketones, such as cyclohexanone, methyl ethyl ketone and acetone, esters, such as butyl acetate and adipic esters, and petroleum fractions, such as white spirits.

In a further aspect the present invention refers to a method of obtaining a coated substrate, such as a heat sensitive substrate selected from the group consisting of for instance wood, plastic or paper, said method comprises applying a coat of the polyurethane coating composition, obtained by the process disclosed above, onto a substrate and subsequently stoving obtained coated substrate at 50-100° C. during for instance 30-120 minutes.

The following non-limiting examples illustrate the invention.

### EXAMPLE 1

Synthesis of a formulation formed of Tolonate® HDT blocked with 2-ethylimidazole.

1210 g of N-methylpyrrolidone (NMP) and 1202 g of Tolonate® HDT, Rhodia, with an NCO content of 0.52 mol per 100 g (i.e. 6 mol of NCO), were successively added to a 6 1 jacketed three-necked reactor equipped with a stirrer and a reflux condenser. The reaction mixture was stirred and 619 g of 2-ethyl imidazole with a purity of 98% (molecular weight: 96.13), i.e. 6.3 mol, were added over 5 min. The temperature of the reaction medium increased from 20° C. to 69.4° C. after the addition of the blocking agent. The reaction medium was then heated at 80° C. and maintained until the IR spectrum indicated that virtually all isocyanate groups had reacted, i.e. 4 hrs. after addition of the blocking agent. The product was, after cooling to ambient temperature, decanted into a receiving bottle.

Yielded blocked product exhibited following characteristics:

Theoretical NCO content: 0.206 mol/100 g of solution

Solid content: 60.2%
Viscosity: 760 mPas at 25° C.

Preparation was, for all examples, carried out as for example 1 using, as starting polyisocyanates, Tolonate® HDT, Rhodia, with an NCO content of 0.52 mol per 100 g, Tolonate® DB (Biuret), Rhodia, with an NCO content of 22% by weight, or Tolonate® HDT HR, Rhodia, and, as blocking agents, 2-ethylimidazole or 2-propylimidazole or in 50/50 mol % mixtures with 3,5-dimethylpyrazole. After storing in the laboratory for 10 months, the products did not show any signs of gelling. The characteristics of obtained products are presented in the Table I below.

Obtained blocked isocyanates were evaluated in a varnish based on Joncryl® SC 922X (acrylic polyol, having 4.4% OH and a solid content of 80%, S.C. Johnson) in the absence of catalyst. The NCO/OH ratio was 1.05 and the solid content during application was 60%.

The varnishes were applied on glass panels using an applicator at 100 μm wet film. After a 30 min. flash-off, stoving was carried out at 80° C. or 120° C. for 30 min. The varnish films were subsequently cooled to ambient temperature, and the Persoz hardness was measured and the chemical resistance evaluated by means of the “MEK (methyl ethyl ketone) double rubs” test.

Products thus obtained and evaluated are presented in Table II below.

The stability of the varnishes was evaluated by leaving the 2K varnishes at 23° C. The products based on propylimidazole appear to be slightly less reactive. The HDT blocked with ethylimidazole gives the most advantageous results in terms of stability on storage. Stability on storage at 23° C. without catalyst is given in Figures I and II below.

TABLE I

| | | Solid | Viscosity |
|---|---|---|---|
| | | content | mPas at |
| Type | NCO % | % in NMP | 23° C. |
| HDB blocked with ethylimidazole | 9.35 | 65 | 4070 |
| HDB blocked with propylimidazole | 8.62 | 65 | 3286 |
| HDB blocked with ethylimidazole/ | 9.36 | 65 | 1970 |
| 3,5-DMP (50/50) | | | |
| HDT-HR blocked with ethylimidazole | 9.34 | 65 | 2410 |
| HDT-HR blocked with | 8.62 | 65 | 3108 |
| propylimidazole | | | |
| HDT-HR blocked with ethylimidazole/ | 9.36 | 65 | 1390 |
| 3,5-DMP (50/50) | | | |
| HDT blocked with ethylimidazole | 8.60 | 65 | — |
| HDT blocked with propylimidazole | 8.49 | 65 | 1200 |
| HDT blocked with ethylimidazole/ | 9.20 | 65 | 1193 |
| 3,5-DMP (50/50) | | | |

TABLE II

| | 30 min 90° C. | | 30 min 120° C. | |
|---|---|---|---|---|
| | Persoz | MEK double | Persoz | MEK double |
| | hardness | rubs | hardness | rubs |
| HDT blocked with ethylimidazole | 170 | >200 | 305 | >200 |
| HDB blocked with ethylimidazole | 172 | >200 | 305 | >200 |
| HDT-HR blocked with ethylimidazole | 222 | >200 | 318 | >200 |
| HDB blocked with ethylimidazole/3,5-DMP (50/50) | 78 | 10 | 117 | >200 |
| HDT-HR blocked ethylimidazole/3,5-DMP (50/50) | 74 | 10 | 126 | <200 |
| HDT blocked ethylimidazole/3,5-DMP (50/50) | 67 | 10 | 147 | >200 |
| HDT-HR blocked with propylimidazole | 120 | >200 | 300 | >200 |
| HDB blocked with propylimidazole | 121 | 150 | 311 | >200 |
| HDT blocked with propylimidazole | 180 | >200 | 323 | >200 |

Each patent, patent application, and literature article cited or indicated herein is hereby expressly incorporated by reference in its entirety

While the invention has been described in terms of various specific and preferred embodiments, the skilled artisan will appreciate that various modifications, substitutions, omissions, and changes may be made without departing from the spirit thereof. Accordingly, it is intended that the scope of the present invention be limited solely by the scope of the following claims, including equivalents thereof.

What is claimed is:

1. A process of manufacturing a polyurethane coating composition, said process comprising:
a) forming at least one blocked isocyanate wherein at least 75% of reactive isocyanate groups are blocked by mixing at least one isocyanate functional compound with at least one imidazole selected from the group consisting of a 2-monoalkyl substituted imidazole, a 4-monoalkyl substituted imidazole, a 5-monoalkyl substituted imidazole, a 2,4-dialkyl substituted imidazole, a 4,5-dialkyl substituted imidazole and a 2,4,5-trialkyl substituted imidazole, and
b) mixing said at least one blocked isocyanate with at least one polyhydric compound,
wherein the coating composition has a pot-life of at least 8 hours and a de-blocking temperature of 50-100° C.

2. The process according to claim 1, wherein said alkyl is a C₁-C₁₀ linear or branched alkyl or cycloalkyl.

3. The process according to claim 1, wherein said imidazole is 2-ethylimidazole, 4-methylimidazole, 2-ethylimidazole, 2-propylimidazole, 2-isopropylimidazole, 2-ethyl-4-methylimidazole, or 4-methyl-5-hydroxymethylimidazole.

4. The process according to claim 1, wherein said aliphatic isocyanate functional compound is an isocyanate monomer, an isocyanate oligoconensate obtained from one pr more isocyanate monomers, or a mixtures of at least one said oligocondensate and at least one said monomer.

5. The process according to claim 4, wherein said oligocondensate is a biuret, a dimer, a trimer, an isocyanurate, a carbamate, an uretidinedione or an allophanate.

6. The process according to claim 4, wherein said oligocondensate comprises isocyanuric rings obtained from three isocyanate functional groups.

7. The process according to claim 4, wherein said isocyanate is tetramethylene diisocyanate, hexamethylene diisocyanate, isophorone diisocyanate, norbonane diisocyanate, 1,3-bis(isocyanatemethyl)cyclohexane, cyclohexane-1,4-diisocyanate, tetrahydrofuran diisocyanate, or a oligocondensate obtained from one or more of said diisocyanates.

8. The process according to claim 5, wherein said isocyanate is tetramethylene diisocyanate, hexamethylene diisocyanate, isophorone diisocyanate, norbonane diisocyanate, 1,3-bis(isocyanatemethyl)cyclohexane, cyclohexane-1,4-diisocyanate, tetrahydrofuran diisocyanate, or a oligocondensate obtained from one or more of said diisocyanates.

9. The process according to claim 1, wherein said polyhydric compound is a hydroxyfunctional polyacrylate or a hydroxyfunctional polyester having a molecular weight Mw of 3,000-50,000 g/mole.

10. The process according to claim 1, wherein said coating composition further comprises at least one pigment, surface active agent, organic solvent, catalyst and/or dehydrating agent.

11. A method of obtaining a coated substrate, said method comprising applying a coat of the polyurethane coating composition according to claim 1 onto a substrate and subsequently stoving obtained coated substrate at 50-100° C.

12. The method according to claim 11, wherein said coated substrate is stoved at said temperature during 30-120 minutes.

13. The method according to claim 11, wherein said substrate is wood, plastic or paper.

14. A polyurethane coating composition obtained by the process according to claim 1, said composition comprising
a) at least one isocyanate functional compound, wherein at least 75% of reactive isocyanate groups are blocked with at least one imidazole selected from the group consisting of a 2-monoalkyl substituted imidazole, a 4-monoalkyl substituted imidazole, a 5-monoalkyl substituted imidazole, a 2,4-dialkyl substituted imidazole, a 4,5-dialkyl substituted imidazole and a 2,4,5-trialkyl substituted imidazole, and
b) at least one polyhydric compound,
wherein the coating composition is suitable for use on heat sensitive substrates and has a pot-life of at least 8 hours and a de-blocking temperature of 50-100° C.

15. The composition according to claim 14, wherein said alkyl is C₁-C₁₀ linear or branched alkyl or cycloalkyl.

16. The composition according to claim 14, further comprising at least one pigment, surface active agent, organic solvent, catalyst and/or dehydrating agent.

17. A polyurethane coating composition comprising
a) at least one isocyanate functional compound, wherein at least 75% of reactive isocyanate groups are blocked with at least one imidazole selected from the group consisting of a 2-monoalkyl substituted imidazole, a 4-monoalkyl substituted imidazole, a 5-monoalkyl substituted imidazole, a 2,4-dialkyl substituted imidazole, a 4,5-dialkyl substituted imidazole and a 2,4,5-trialkyl substituted imidazole, and
b) at least one polyhydric compound.
wherein the coating composition is suitable for use on heat sensitive substrates and has a pot-life of at least 8 hours and a de-blocking temperature of 50-100° C.

18. The composition according to claim 17, wherein said alkyl is C₁-C₁₀ linear or branched alkyl or cycloalkyl.

19. The composition according to claim 17, further comprising at least one pigment, surface active agent, organic solvent, catalyst and/or dehydrating agent.
